(19) United States
(12) Patent Application Publication
(10) Pub. No.: US 2005/0242956 A1
(43) Pub. Date: Nov. 3, 2005

(54) Magnetic marker for use in product authentication, and detector for reading the marker

(75) Inventor: Evgeni Sorkine, Tel Aviv (IL)

Correspondence Address: BROWDY AND NEIMARK, P.L.L.C.;624 NINTH STREET, NW, SUITE 300, WASHINGTON, DC, 20001-5303, US

(73) Assignee: A.C.S. Advanced Coding Systems Ltd., Even Yehuda (IL)

(21) Appl. No.: 11/070,664

(22) Filed: Mar. 3, 2005

(30) Foreign Application Priority Data
May 3, 2004 (GB) 0404933.4

(51) Int. Cl. G08B 13/14

(52) U.S. Cl. 340/572.6; 235/493

(57) ABSTRACT

A magnetic tag is presented, as well as a method for manufacturing such a tag and a detector device and method for use in product authentication. The tag comprises a soft magnetic unit and a hard magnetic unit in its non-magnetized state both carried by a substrate. The soft magnetic unit includes at least one glass-coated amorphous microwire characterized by a large Barkhausen discontinuity and a zero or positive magnetostriction. The hard magnetic unit includes at least one strip-like element of a thickness substantially not exceeding a few tens of microns printed onto the substrate so as to extend along an axis parallel to the microwire. The hard magnetic material has coercivity substantially higher than 1000 Oe. The hard magnetic unit is thus such that, once magnetized, in order to be de-magnetized needs to be subjected to more than a single pulse of an alternating magnetic field of intensity varying from that of at least 250% of the coercive force value of the hard magnetic material to zero.

### FIELD OF THE INVENTION

This invention relates to a magnetic marker, particularly useful for product authentication purposes, and a detector for use with this marker.

### BACKGROUND OF THE INVENTION

Identifying of the originality of products is very important in production and distribution of various products. Considerable efforts have been undertaken throughout the world in the field of protecting the authenticity of goods.

It is known to use optical means, such as special printing and holograms, for product authentication purposes. The problem with such optical means is associated with the fact that printed authentication optical tags can easily be counterfeited, while the holograms authenticity of holograms can be verified only by means of special optical equipment. Additionally, optical means are very sensitive to environmental conditions, such as dirt, humidity, as well as mechanical wear.

Magnetic identification means are also widely used, in particular, in anti-shoplifting systems, called electronic article surveillance (EAS) systems. EAS markers made of soft magnetic amorphous alloy ribbons are disclosed for example in U.S. Pat. No. 4,484,184. The commonly accepted shape of such a marker is that of an elongated strip. Magnetic EAS markers are rather robust and flexible. Also, they are mostly provided with deactivation elements made of semi-hard magnetic materials.

U.S. Pat. No. 4,960,651 discloses magnetic devices which include an article comprising a substrate and a thin coating (not greater than 6 microns in thickness) of a magnetic material. The substrate is a flexible, laminar material. The magnetic material is an amorphous metal glass of high intrinsic magnetic permeability, with low or substantially zero magnetostriction, and with low coercivity. This article can be used as, or to make, an antipilferage tag or marker. Deactivation materials and configurations are also disclosed, as well as techniques, in particular sputtering or PVD, for producing such a tag.

U.S. Pat. No. 5,582,924 discloses a tag or marker which comprises a substrate; an ‘active’ magnetic material which is a soft magnetic material having a high magnetic permeability and a low coercive force; and a deactivating material which is a hard or semi-hard magnetic material having a moderate or high coercive force and a moderate magnetic permeability. The deactivating material, when subjected to a sufficiently high magnetizing force, is able to clamp the magnetic properties of the ‘active’ material so as to deactivate the ‘active’ material. The deactivating material in the tag or marker is electrodeposited nickel with a planar crystal grain structure.

U.S. Pat. No. 6,538,572 discloses the use of a paintable or printable bias magnet material instead of the conventional bias magnets in EAS markers. This material is either directly painted onto the EAS marker or first placed onto a substrate material, which is then placed into the EAS marker. The material includes a magnetic powder mixed with resin and solvent. This “bias paint” is then applied onto the EAS marker. The magnetic powder, resin, and solvent provide a very dense layer after drying, which has a magnetic material density that is usually lower than a rolled product, but is higher than that of the injection-molded magnet material. Printing the bias magnet allows nondeactivatable magnetomechanical EAS markers to be made using web-based mass production methods.

It is often the case that a magnetic marker that can be effectively used in an EAS system is not suitable for authentication purposes. This is because EAS techniques simply require the detection of presence of some magnetic element, while authentication requires distinguishing this magnetic element from other magnetic elements. For example, an amorphous ribbon based EAS marker is not convenient for article authentication, because of amorphous ribbon availability on the market and possible counterfeit. Additionally, the amorphous strip marker is typically characterized by the minimum strip width of about 0.5 mm, and therefore it is difficult to conceal the magnetic element of the marker. Another problem with the conventional EAS markers is that their deactivating element can be easily reactivated thus enabling the repeated use of the protected item.

U.S. Pat. No. 6,556,139, assigned to the assignee of the present application, discloses a magnetic tag for use with various kinds of products for the product authentication purposes. The tag is characterized by its unique response to an external alternating magnetic field. The tag utilizes at least one magnetic element formed of a glass-coated amorphous magnetic microwire characterized by a large Barkhausen discontinuity and a zero or positive magnetostriction. Such a microwire is therefore characterized by fast re-magnetization, and, when located in a region of an alternating magnetic field, produces short pulses of the field perturbations.

### SUMMARY OF THE INVENTION

There is a need in the art to improve the item (product) authentication, by providing a novel magnetic tag configured to allow disabling (destroying) the authentication feature of a tag, after the tag has been read (i.e., the product has been found to be authentic). This is aimed at eliminating the fraud by repeated use of the item, and is particularly useful for example when authenticating of food stamps, transportation tickets, tickets for shows, theatre, sports games, and so on, as well emptied bottles and cans due to deposit money return.

The present invention solves the above problem by providing a novel magnetic tag configured to be activated and, once deactivated (while being read for authenticating a product with which the tag is associated), cannot be reactivated in a conventional way. The magnetic authentication tag of the present invention has a simple and not expensive construction, and may also carry a certain amount of additional information about the product.

In accordance with the invention, the deactivatable magnetic authentication tag utilizes a soft magnetic unit and a hard magnetic unit. Here, the term “deactivatable tag” actually signifies a tag which is hard to return from its deactivated state to its active state, namely a tag which in order to be returned into its active state needs much more complicate magnetic field treatment to be applied to the tag.

The soft magnetic unit includes at least one glass-coated amorphous magnetic microwire characterized by a large Barkhausen discontinuity and a zero or positive magrietostriction (as disclosed in the above indicated U.S. Pat. No. 6,556,139 assigned to the assignee of the present application). Such a microwire is therefore characterized by fast re-magnetization (unique re-magnetization peak width), and thus when located in a region of an alternating magnetic field, produces short pulses of the field perturbations. If a plurality of the microwires is used, the microwires are arranged in a spaced-apart parallel relationship extending across the entire tag length or a part of it.

The hard magnetic unit may comprise a single hard magnetic element (strip), but preferably includes an array of hard magnetic elements (strip segments) arranged in a spaced-apart relationship along an axis parallel to the microwire (microwires). The hard magnetic unit (presenting continuous deactivator or deactivator pattern) is made from a magnetic paint of high coercivity such that it after being shifted from its initial non-magnetized state to a magnetized state cannot be easily returned to the non-magnetized state. When the hard magnetic unit is magnetized (i.e., the tag is de-activated), the characteristic microwire response is totally suppressed due to saturation. When the hard magnetic unit is non-magnetized (i.e., the tag is active), the response of the soft magnetic unit can be detected.

The use of the glass-coated amorphous microwire(s) as a soft magnetic unit allows for making the hard magnetic strip very thin, thus allowing for using non-expensive printing techniques for producing the hard magnetic unit of the tag. More specifically, in the conventional EAS markers, utilizing a soft magnetic strip and a bias-element magnetic strip, the thickness of the bias element is typically at least 0.2-0.3 mm, as disclosed in the above-indicated U.S. Pat. No. 6,538,572. Hence, conventional printing techniques can hardly be used for manufacturing the bias element. On the contrary, the technique of the present invention requires the thickness of the hard magnetic unit to be about 20-30 μm because the metal core diameter of the microwire is about 15-20 μm.

Thus, according to one broad aspect of the present invention, there is provided a magnetic tag for attaching to or incorporating within a product to enable authentication of the product, the tag comprising:
a soft magnetic unit carried by a substrate, the soft magnetic unit comprising at least one glass-coated amorphous microwire characterized by a large Barkhausen discontinuity and a zero or positive magnetostriction; and
a hard magnetic unit in its non-magnetized state located on said substrate such that the hard magnetic unit extends along an axis substantially parallel to the microwire, the hard magnetic unit is made of a hard magnetic material printed onto the substrate to form at least one strip-like element of a thickness substantially not exceeding a few tens of microns, the hard magnetic material having coercivity substantially higher than 1000 Oe, the hard magnetic unit thus being such that, once magnetized, in order to be de-magnetized needs to be subjected to more than a single pulse of an alternating magnetic field of intensity varying from that of at least 250% of the coercive force value of the hard magnetic material to zero.

Hence, the normally active magnetic tag (i.e., with the hard magnetic unit in its non-magnetized state), after being read once (by detecting the response of the soft magnetic unit to an interrogating field) can be immediately deactivated (by shifting the hard magnetic unit from its initial non-magnetized state to the magnetized state), thereby impeding further reactivation of the tag. Practically, the AC magnetic field capable of de-magnetizing the previously magnetized hard magnetic unit should be at least 250% of the coercivity force of the hard magnetic material (e.g., for the hard magnetic material having coercivity of 1000 Oe, such a filed should be of at least 2500 Oe).

According to another aspect of the invention, there is provided a method of manufacturing a magnetic tag to be used with a product to enable authentication of the product, the method comprising:
providing at least one glass-coated amorphous microwire characterized by a large Barkhausen discontinuity and a zero or positive magnetostriction, to form a soft magnetic unit on a substrate,
selecting a hard magnetic material of a coercivity substantially higher than 1000 Oe, and printing the hard magnetic material in its non-magnetized state on the substrate to form a hard magnetic unit extending along an axis parallel to the microwire and including at least one strip-like element of a thickness substantially not exceeding a few tens of microns, the hard magnetic unit thus being such that, once magnetized, in order to be de-magnetized needs to be subjected to more than a single pulse of an alternating magnetic field of intensity varying from that of at least 250% of the coercive force value of the hard magnetic material to zero.

According to yet another broad aspect of the invention, there is provided a detector device for use in a product authentication, the detector being configured for detecting a magnetic tag, having a soft magnetic unit and s hard magnetic unit in its non-magnetized state, the detector device comprising:
a source of a first interrogating magnetic field operable to create the alternating magnetic field in an interrogation zone to affect said at least one microwire to produce a response to the first interrogating field;
a receiver for receiving the response of the microwire and generating a signal indicative thereof;
a signal processing utility for receiving said signal, determining whether said signal corresponds to a predetermined duration of the response pulse of the microwire, and generating an output signal;
a tag deactivating assembly configured for generating a second magnetic field for magnetizing said at least one hard magnetic element of the tag; and
an actuator responsive to said output signal to operate the tag deactivating assembly, to thereby magnetize the hard magnetic unit immediately after the generation of said output signal.

According to yet another aspect of the invention, there is provided a method for use in product authentication, the product carrying a magnetic tag that has a soft magnetic unit and a hard magnetic unit in its non-magnetized state, the method comprising:
subjecting the product to a first interrogating magnetic field to thereby activate the soft magnetic unit to produce a response to the field; detecting the response; processing data indicative of the response and upon determining that said data satisfies a predetermined condition, generating an output signal indicative thereof;
in response to said output signal, subjecting the product to a second magnetic field to magnetize the hard magnetic unit of the tag, thereby significantly impeding further de-magnetization of the hard magnetic unit.

### BRIEF DESCRIPTION OF THE DRAWINGS

In order to understand the invention and to see how it may be carried out in practice, preferred embodiments will now be described, by way of non-limiting examples only, with reference to the accompanying drawings, in which:

FIG. 1 is a schematic illustration (with portions broken away) of a magnetic authentication tag of the present invention:

FIG. 2 is a schematic illustration of a known glass-coated microwire that is suitable to be used in a magnetic tag of the present invention;

FIG. 3 exemplifies the hysteresis loop characteristic of the glass-coated amorphous microwire of FIG. 2, for the microwire having a magnetic core made of cobalt-based alloy with zero magnetostriction;

FIGS. 4A to 4C illustrate differences in re-magnetization processes in magnetic elements of markers made of a glass-coated microwire used in the present invention, an in-water cast amorphous wire, and an amorphous strip;

FIG. 5 more specifically illustrates the configuration of soft and hard magnetic units of the tag of FIG. 1; and

FIG. 6 exemplifies a detector unit according to the invention for reading (detecting) a magnetic tag.

includes at least one strip-like hard magnetic element 33—an array of three such spaced-apart hard magnetic elements 33 being shown in the present example, with each of the hard magnetic elements 33 overlapping a region across all the microwires 1. The hard magnetic elements are made of a high coercivity magnetic material printable on the substrate. The hard magnetic material has coercivity substantially higher than 1000 Oersteds, practically at least 2000 Oersteds. The thickness of the hard magnetic element suitable for the purposes of the present invention is about 20-30 micrometers, and the hard magnetic element can therefore be printable on the substrate.

In the present example, the hard magnetic elements 33 are printed on the substrate 106, and the microwire pieces 1 are sandwiched between the substrate 106 with the printed hard magnetic elements and an overlayer 108 of the tag. The external surface of the substrate 106 may be coated with a suitable adhesive microwire properties can be controlled by varying the alloy composition and the glass-to-metal diameter ratio. Particularly, the microwires that are cast from alloys with zero or positive magnetostriction are characterized by a large Barkhausen discontinuity, and can advantageously be used for product authentication purposes (U.S. Pat. No. 6,556,139) due to their unique property of re-magnetization in an external alternating magnetic field, namely, unique re-magnetization peak width, resulting in a short response pulse of the microwire to the external field. To this end, a Co-based or Fe-based alloy can be used, for example, one of the following: an alloy containing 77.5% Co, 4.5% Fe, 12% Si, and 6% B by atomic percentage, an alloy containing 68.6% Co, 4.2% Fe, 12.6% Si, 11% B, 3.52% Cr and 0.08% Mo by atomic percentage, or an alloy containing 60% Fe, 15% Co, 15% Si and 10% B.

FIG. 3 shows an example of the hysteresis loop measured in a sample (glass-coated microwire) prepared from the alloy containing 77.5% Co, 4.5% Fe, 12% Si, and 6% B, characterized by zero magnetostriction. The diameter of the inner metal part for this sample is 15-20 micrometers. The total diameter of the microwire sample is 17-22 micrometers. As shown, the microwire sample is characterized by a large Barkhausen discontinuity.

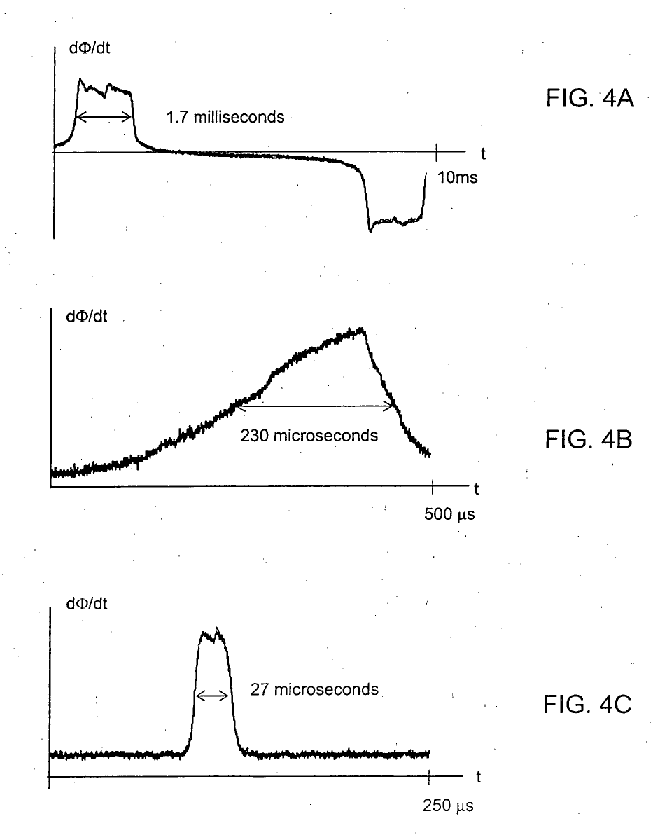

The process of re-magnetization of such a microwire (with zero or positive magnetostriction and a large Barkhausen discontinuity) is faster than that of any other magnetic material. This is illustrated in FIGS. 4A-4C showing the differences in re-magnetization processes in three samples: amorphous strip (typically used in anti-shoplifting, or EAS markers), an in-water cast amorphous wire (used in the EAS markers commercially available from Sensormatic Co.), and the glass-coated microwire described above. A triangular-waveform AC external field of a rather low frequency (about 100 Hz) and small amplitude of approximately 100 Å/m was applied to the above mentioned samples. The partial waveform graphs are depicted in FIGS. 4A-4C. When the field strength achieves the coercive force value H_{c}, then the re-magnetization process starts. The magnetic flux changes give rise to a peak in the flux derivative over time, dΦ/dt (in arbitrary units). Accordingly, a voltage peak is observed in a receiving coil placed in the vicinity of the sample. As shown, the re-magnetization peak width (measured at half amplitude level) is 30 to 100 microseconds for the glass-coated microwire (the solid curve, a). For the markers commercially available from Sensormatic Co. comprising an in-water-cast amorphous wire with large Barkhausen discontinuity, the peak width is 300 to 500 microseconds, and more (the dotted curve, b). For amorphous strips typically used in anti-shoplifting markers, like a Meto GmbH 32-mm marker, the peak width is 1-2 milliseconds (the dashed curve, c). Other magnetic materials feature much slower re-magnetization process and wider peaks.

Hence, by discriminating the ultimately short re-magnetization peaks of the glass-coated microwire, characterized by zero or positive magnetostriction and a large Barkhausen discontinuity, it is possible to unambiguously detect its presence in an authentication tag.

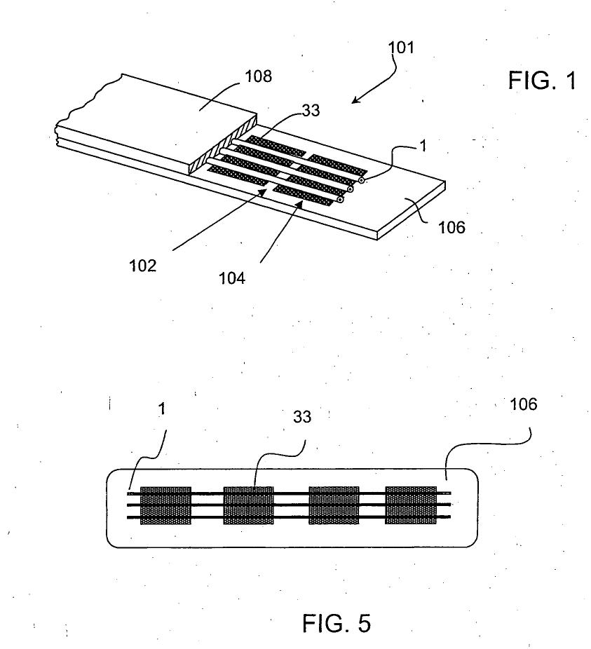

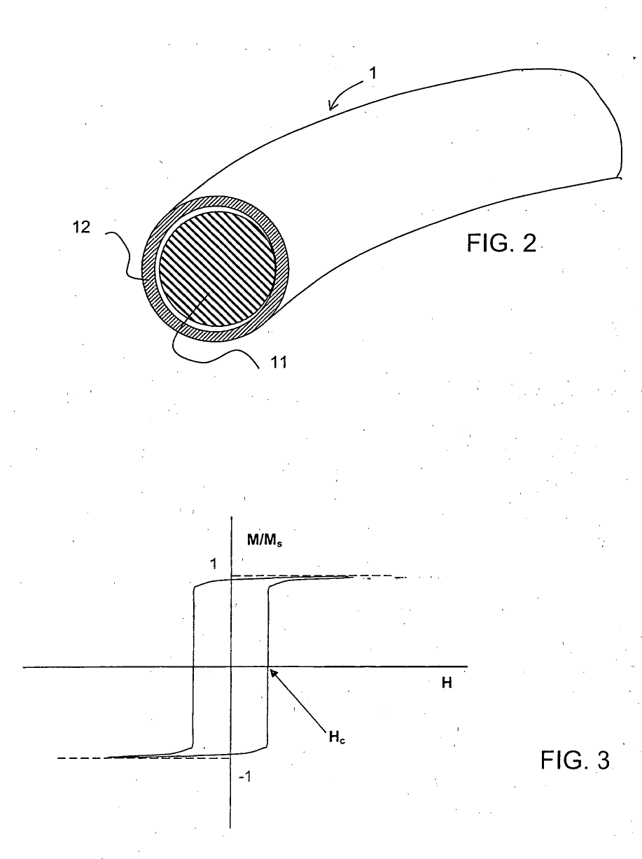

Turning back to FIG. 1, the magnetic tag 101 operates as follows: When the hard magnetic elements are not magnetized (the tag is active), they do not influence the tag response (i.e., the response of the soft magnetic unit 102 to an interrogating magnetic field). When the hard magnetic unit 104 of the tag is magnetized (the tag is deactivated), it brings the microwires 1 to saturation, and the characteristic response of the soft magnetic unit 102 is therefore suppressed.

A product is typically marketed with a tag in its active state (non-magnetized hard magnetic unit), and thus detecting a unique response of the soft magnetic unit allows for authenticating the product.

According to the technique of the present invention, after the product is authenticated, the tag is shifted into its non-active state, in which state the hard magnetic unit is magnetized. The hard magnetic unit used in the tag of the present invention is made of a material with a coercivity significantly higher than 1000 Oersteds, and therefore, when magnetized, cannot be easily (with the conventional means) shifted back into its non-magnetized state. The minimal magnetic field capable of magnetizing the hard magnetic unit (deactivation of the tag) is about 250% of the coercive force value of the hard magnetic material. For the hard magnetic material with a 1000 Oe coercivity force, the magnetizing magnetic field should be at least 2500 Oe. The magnetization process can easily be implemented using a rare earth magnet or a strong magnetic field pulse (using for example a capacitor discharge through a solenoid coil). As for the demagnetization of such a high-coercivity magnetic material (return of the hard magnetic unit in its non-magnetized state), this would require a complex procedure of subjecting the tag to an alternating magnetic field with varying intensity starting from a very high intensity (at least 250% of the coercivity force value of the material) and fading to zero during a certain time period including several tens of cycles of the alternating magnetic field.

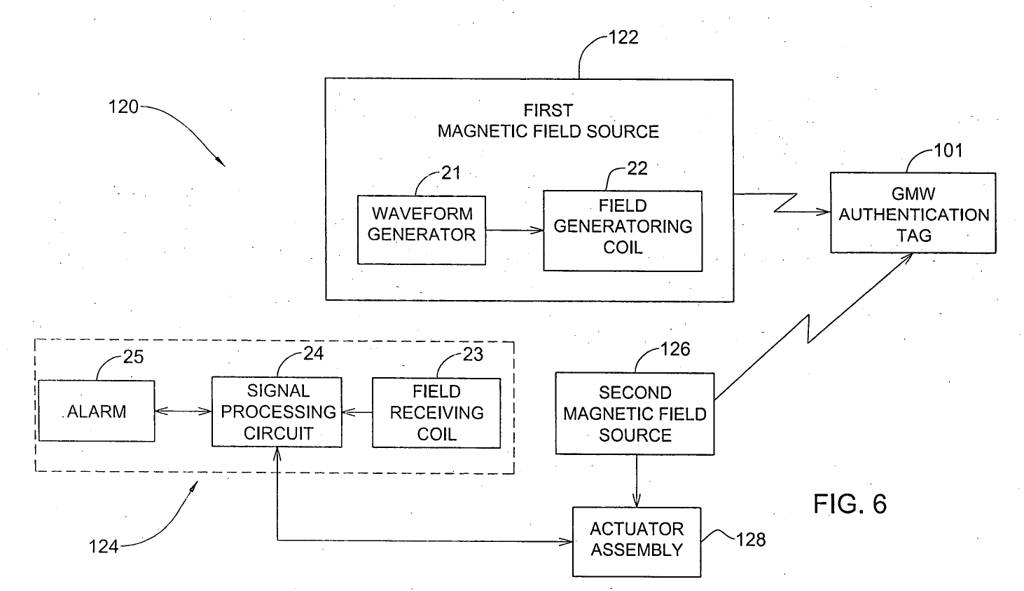

To this end, a detector unit according to the invention is designed to include, in addition to a tag reading assembly, also a tag deactivating assembly (as described above), and an actuator configured to be responsive to the tag reading assembly to detect that the product has been authenticated, to immediately operate the tag deactivating assembly. This will be described below with reference to FIG. 6.

By choosing the material of the hard magnetic elements 33 among those known by very high coercive force values (preferably more than 2000 Oersteds), the tag re-activation process becomes very difficult. Indeed, to demagnetize such material, a series of alternating field pulses of initial intensity 250% of the coercive force value of the hard magnetic material and with pulse amplitudes fading to zero should be applied to the tag. Semi-hard magnetic materials typically used as EAS tag deactivation elements have coercive forces of about 40 to 100 Oersteds, and can therefore be easily de-magnetized with commercially available AC electromagnets. However, for a very hard material with more than 1000 Oersteds coercivity, the demagnetization process requires special, very powerful installations that are not available from the shelf.

Such high coercivity hard magnetic materials are known and available in the market. In the bulk form, all the strong magnets are brittle. For this reason, it is impossible to handle these materials in the way similar to that of EAS tag manufacturing (wherein strips of deactivator metal are either cut to pieces or thermally treated in parts, to make an intermittent structure of small magnets along the soft magnetic element).

For the purposes of the present invention, it is advantageous to use the hard magnetic material in a powder form. This powder may be mixed with a lacquer or a paint base material, to form a magnetic paint. Then, the single continuous deactivator or deactivator element pattern 33 may be simply printed on the tag substrate 106, as it is shown in FIG. 5.

The inventors have tried fine powders of iron and cobalt oxides, strontium and barium ferrites, as deactivator materials. In particular, strontium ferrite powder SrFe₁₂O₁₉ was found to give good deactivation performances. The material has the intrinsic coercivity about 4,000 Oersteds. Powder with particle size around 5 microns was mixed with the silkscreen paint base, and a pattern of successive rectangles was printed then on a paper substrate. The rectangles had sizes of 2 mm width and 6 mm length, with spacing of 2 mm between the rectangles. The dry paint layer thickness was about 20 microns. After printing, the glass-coated microwires of 20 microns core diameter were glued over the deactivator pattern, as is shown in FIG. 5.

In the initial state, the deactivator elements are not magnetized due to random orientation of the powder particles. The specific microwire response is not influenced. After the deactivator magnetization by a FeNdB rare earth magnet, the microwire signal was totally suppressed. All attempts to re-activate the “killed” tags with available AC electromagnets were unsuccessful.

FIG. 6 exemplifies, by way of a block diagram, a detector device 120 according to the invention for use with the magnetic authentication tag 101 of the present invention. The detector device 120 typically includes an interrogating magnetic field source 122, formed by a waveform generator block 21 and a field generating coil 22, for creating a first alternating magnetic field in an interrogation zone. This first magnetic field is aimed at reading the tag, namely to cause a response of the soft magnetic unit, and is of about a few Oersteds. Further typically provided in the detector device 120 are: a response receiver unit 124 including a field receiving coil 23; a signal processing circuit 24 preprogrammed to determine whether the response satisfies a predetermined condition and generate an output signal indicative thereof; and an indicator utility (alarm device) 25. Considering the use, in the soft magnetic unit, the glass-coated amorphous microwire(s) characterized by a large Barkhausen discontinuity and a zero or positive magnetostriction, the signal processing circuit 24 is of a kind capable of determining a duration of the response pulse and generating the output signal indicative of whether the duration satisfies a predetermined value.

According to the present invention, the detector device 120 further includes a deactivating assembly 126 (including for example a rare earth magnet or a generator of a strong magnetic field pulse as described above); and an actuator 128 interconnected between the output of the signal processing circuit 24 and input of the deactivating assembly 126 to thereby actuate the deactivating assembly immediately after the generation of said output signal (i.e., after the product has been authenticated). It should be understood that the deactivating assembly and/or the actuator may and may not be contained in the same housing as the other elements of the detector device.

When the tag 101 (a product with the tag) is located in the vicinity of the coils 22 and 23 (i.e., in the interrogation zone), the interrogating AC field causes the switching of the microwire pieces magnetization, considering the tag is in its initial active state (non-magnetized hard magnetic unit). Accordingly, very short pulses of magnetic field perturbations are received by the field receiving coil 23. These pulses are detected by the signal processing circuit 24, which produces an output to activate the alarm 25 (which may be a buzzer or LED, or both) and to activate the actuator 128, which operates the deactivating assembly to create a pulse of a high magnetic field and thus shift the hard magnetic unit of the tag into its magnetized state (non-active state of the tag).

For authentication of products of a specific type, the design of coils 22 and 23 may be chosen in accordance with the particular application. For example, these coils may be wound on a ferrite rod, or a ferrite ring with an air gap.

The principle of the microwire detection disclosed herein may be combined with other methods known in the art, for increasing the information quantity contained in the tag. For example, the soft-magnetic unit may include multiple microwire pieces with different coercivities. In this case, several re-magnetization peaks will be detected in each period, and their pattern may be recognized, for example, by methods described in U.S. Pat. No. 4,203,544. Different coercivity values of the microwires may be obtained, for example, by varying the iron content in the master alloy composition, and/or the glass coat thickness, as pointed in the above-indicated article of Antonenko et al.

If, in addition, the deactivator pattern (hard magnetic elements) is intentionally made non-uniform, with varying lengths of the printed rectangles, then a certain amount of additional information may be extracted after the deactivator is magnetized. The principle of information reading is similar to that of magnetic bar code readers, which are well known in the art. Alternatively, the spacing between the identical deactivator rectangles may be varied. In this case, the residual signals of the non-saturated microwire parts in these spacings may be successively detected and processed to form a code. The inventors have found that at least a 6-bit code could be read in a tag with 30 mm microwire length.

Those skilled in the art will readily appreciate that various modifications and changes can be applied to the invention as hereinbefore exemplified without departing from its scope defined in and by the appended claims.

1. A magnetic tag for attaching to or incorporating within a product to enable authentication of the product, the tag comprising:
a soft magnetic unit carried by a substrate, the soft magnetic unit comprising at least one glass-coated amorphous microwire characterized by a large Barkhausen discontinuity and a zero or positive magnetostriction; and
a hard magnetic unit in its non-magnetized state located on said substrate such that the hard magnetic unit extends along an axis substantially parallel to the microwire, the hard magnetic unit is made of a hard magnetic material printed onto the substrate to form at least one strip-like element of a thickness substantially not exceeding a few tens of microns, the hard magnetic material having coercivity substantially higher than 1000 Oe, the hard magnetic unit thus being such that, once magnetized, in order to be de-magnetized needs to be subjected to more than a single pulse of an alternating magnetic field of intensity varying from that of at least 250% of the coercive force value of the hard magnetic material to zero.

2. The magnetic tag of claim 1, wherein the hard magnetic material coercivity is at least 2000 Oersteds.

3. The magnetic tag of claim 1, wherein the hard magnetic material includes at least one of strontium ferrite and barium ferrite powder materials.

4. The magnetic tag of claim 1, wherein said at least one microwire is configured to be uniquely re-magnetizable by a certain alternating magnetic field to produce at least one short pulse response to the magnetic field.

5. The magnetic tag of claim 1, wherein the thickness of the hard magnetic element ranges from a few microns to a few tens of microns.

6. The magnetic tag of claim 1, wherein the thickness of the hard magnetic element is about 20-30 microns.

7. The magnetic tag of claim 1, wherein said at least one microwire is located on top of said at least one hard magnetic element being fixed thereto.

8. The magnetic tag of claim 1, wherein said at least one hard magnetic element is printed into the substrate such that said at least one microwire is located between the substrate and the hard magnetic element.

9. A method of manufacturing a magnetic tag to be used with a product to enable authentication of the product, the method comprising:
providing at least one glass-coated amorphous microwire characterized by a large Barkhausen discontinuity and a zero or positive magnetostriction, to form a soft magnetic unit on a substrate,
selecting a hard magnetic material of a coercivity substantially higher than 1000 Oe, and printing the hard magnetic material in its non-magnetized state on the substrate to form a hard magnetic unit extending along an axis parallel to the microwire and including at least one strip-like element of a thickness substantially not exceeding a few tens of microns, the hard magnetic unit thus being such that, once magnetized, in order to be de-magnetized needs to be subjected to more than a single pulse of an alternating magnetic field of intensity varying from that of at least 250% of the coercive force value of the hard magnetic material to zero.

10. The method of claim 9, wherein the hard magnetic material coercivity is at least 2000 Oersteds.

11. The method of claim 9, wherein the hard magnetic material includes at least one of strontium ferrite and barium ferrite powder materials.

12. The method of claim 9, wherein said at least one microwire is configured so as to be uniquely re-magnetizable by a certain alternating magnetic field to produce at least one short pulse response to the magnetic field.

13. The method of claim 9, wherein the thickness of the hard magnetic element ranges from a few microns to a few tens of microns.

14. The method of claim 9, wherein the thickness of the hard magnetic element is about 20-30 microns.

15. The method of claim 9, wherein said at least one microwire is secured onto the substrate such that it is located on top of said at least one hard magnetic element being fixed thereto.

16. The method of claim 9, wherein said at least one hard magnetic element is printed onto the substrate such that said at least one microwire is located between the substrate and the hard magnetic element.

17. A detector device for use in authentication of a product carrying the magnetic tag of claim 1, the detector device comprising:
a source of a first interrogating magnetic field operable to create the alternating magnetic field in an interrogation zone to re-magnetize said at least one microwire to produce a response to the first interrogating field;
a receiver for receiving the response of the microwire and generating a signal indicative thereof;
a signal processing utility for receiving said signal, determining whether said signal corresponds to a predetermined duration of the response pulse of the microwire, and generating an output signal;
a tag deactivating assembly configured for generating a second magnetic field for magnetizing said at least one hard magnetic element of the tag; and
an actuator responsive to said output signal to operate the tag deactivating assembly, to thereby magnetize the hard magnetic unit immediately after the generation of said output signal.

18. A detector device for use in a product authentication, the detector being configured for detecting a magnetic tag, having a soft magnetic unit and a hard magnetic unit in its non-magnetized state, the detector device comprising:
a source of a first interrogating magnetic field operable to create the alternating magnetic field in an interrogation zone to activate the soft magnetic unit to produce a response to the first interrogating magnetic field;
a receiver for receiving the response of the soft magnetic unit and generating a signal indicative thereof;
a signal processing utility for receiving said signal, determining whether said signal satisfies a predetermined condition, and generating an output signal indicative thereof;
a tag deactivating assembly configured for generating a second magnetic field to thereby magnetize the hard magnetic unit of the tag; and
an actuator responsive to said output signal to operate the tag deactivating assembly, to thereby enable to magnetize the hard magnetic unit immediately after the generation of said output signal.

19. A method for use in authentication of a product carrying a magnetic tag that has a soft magnetic unit and a hard magnetic unit in its non-magnetized state, the method comprising:
subjecting the product to a first interrogating magnetic field to thereby activate the soft magnetic unit to produce a response to the field; detecting the response; processing data indicative of the response and upon determining that said data satisfies a predetermined condition, generating an output signal indicative thereof;
in response to said output signal, subjecting the product to a second magnetic field to magnetize the hard magnetic unit of the tag, thereby significantly impeding further de-magnetization of the hard magnetic unit.
